(19) United States
(12) Patent Application Publication
(10) Pub. No.: US 2012/0073230 A1
(43) Pub. Date: Mar. 29, 2012

(54) PRE-ENGINEERED BRICK PANEL AND METHODS OF MAKING AND INSTALLING SAME

(75) Inventors: Mark W. Klein, Santa Ana, CA (US); Leo Litonjua, Santa Ana, CA (US)

(73) Assignee: FMI PRODUCTS, LLC, Santa Ana, CA (US)

(21) Appl. No.: 13/212,067

(22) Filed: Aug. 17, 2011

Related U.S. Application Data
(60) Provisional application No. 61/386,373, filed on Sep. 24, 2010.

(51) Int. Cl. E04B 1/02; E04B 1/38; B23P 17/00; E04B 2/02

(52) U.S. Cl. 52/438; 52/745.21; 29/897.32

(57) ABSTRACT

Disclosed is a pre-engineered brick panel formed of first and second adjacent bricks, spaced apart by a grout joint. The surface of the first brick is adjacent to a surface of the second brick. Each of the adjacent surfaces includes a grout channel and the grout channels in adjacent surfaces are aligned with one another. Grout is disposed in both of the grout joint and the aligned grout channels. Also disclosed are methods for making and installing such pre-engineered panels.

### CROSS-REFERENCE TO RELATED APPLICATION

The present application for patent claims priority under 35 U.S.C. §119 to Provisional Application No. 61/386,373, entitled, “Pre-engineered Brick Panel for Installation into a Fireplace,” filed Sep. 24, 2010, which is expressly incorporated by reference herein in its entirety.

### BACKGROUND

1. Field

This disclosure relates to the mechanical arts. In particular, it relates to a brick panel and methods of making and installing the brick panel.

2. Description of the Related Art

Brick structures, such as brick panels surrounding fireplaces are used as a premium building material due to their strength, beauty, and durability. Unfortunately, brick panels are typically laid brick-by-brick, which tends to be time consuming, labor intensive, and therefore expensive. Consequently, there is a further definite need for a pre-engineered brick panel having the structural integrity needed in order to be moved from a manufacturing facility to a fireplace. There is a further definite need for a pre-engineered brick panel that can be easily and effectively installed to a fireplace.

### SUMMARY

Disclosed is a pre-engineered brick panel has a top portion, a bottom portion and is formed of first and second adjacent bricks, spaced apart by a grout joint. The surface of the first brick is adjacent to a surface of the second brick. Each of the adjacent surfaces includes a grout channel and the grout channels in adjacent surfaces are aligned with one another. Grout is disposed in both of the grout joint and the aligned grout channels.

In some aspects, the first brick adjacent surface is the top surface of the first brick and the second brick adjacent surface is the bottom surface of the second brick. Also in some aspects, a reinforcing material extends into both of the aligned grout channels. In certain of these aspects, the reinforcing material extends along the horizontal length of the panel. Representative reinforcing materials include, without limitation, mesh materials, such as steel wire mesh.

In some aspects, the pre-engineered brick panel has a first support attached to the bottom portion of the brick panel. In certain of these aspects, the first support includes at least one flange extending below the bottom portion of the brick panel. And in further aspects, the pre-engineered brick panel has a second support attached to the top portion of the brick panel. In certain of these aspects, the top portion of the brick panel has a top surface and the second support includes at least one attachment surface spaced above and apart from the top surface. In still further aspects, a fastener is interposed between the top surface and the attachment surface.

Also disclosed is a method of manufacturing a pre-engineered brick panel. The method includes the steps of (a) placing a first surface of a first brick having a first grout channel next to a second surface of a second brick having a second grout channel, to align the grout channels and form a grout joint. Then (b) grout is disposed in the grout channels and the grout joint.

In some aspects, the grout is injected into the grout channels and the grout joints in step (b). And is some aspects, a reinforcing material, including without limitation a mesh material, is placed in the aligned grout channels before disposing the grout in step (b).

And disclosed is a method of installing a pre-engineered panel having a bottom portion with a bottom surface and a top portion to a fireplace having a wall. In some aspects, at least one panel flange is formed on the bottom portion of the panel and extends below the bottom surface. In some of these aspects, the top portion of the panel has a top surface and a support. The support includes at least one attachment surface spaced above and apart from the top surface.

And is some aspects, the panel is formed of first and second adjacent bricks, spaced apart by a grout joint. A top surface of the first brick is adjacent to a bottom surface of the second brick. Each of the adjacent surfaces includes a grout channel and the grout channels in adjacent surfaces aligned with one another. Grout is disposed in the grout joint and both of the aligned grout channels.

The method includes inserting the at least one panel flange into a corresponding slot in a bottom of the fireplace, placing the panel against the wall of the fireplace and attaching a fastener to the top portion of the panel and to the wall of the fireplace to secure the panel to the wall.

In some aspects, the top portion of the panel has a top surface and a support. The support includes at least one attachment surface spaced above and apart from the top surface and the fastener is interposed between the top surface and the attachment surface.

### BRIEF DESCRIPTION OF THE DRAWINGS

The accompanying drawings, together with the specification, illustrate exemplary embodiments, and, together with the description, serve to explain the principles of these embodiments.

FIGS. 1A-C are perspective views of three exemplary bricks;

FIG. 2 is a perspective view of a portion of an exemplary pre-engineered brick panel;

FIG. 3 is a cross-sectional view of a portion of an exemplary pre-engineered brick panel;

FIG. 4 is a perspective view of the rear of an exemplary pre-engineered brick panel; and

FIG. 5 is a perspective view of the front of the pre-engineered brick panel illustrated in FIG. 4.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

As used herein, the term, “brick” is generally intended to include anything that may be utilized for the construction of a panel, such as, for example: ceramic material frequently used in masonry, dry pressed bricks, mud bricks, extruded bricks, calcium silicate bricks; and/or the like. Likewise, as used herein, the term, “grout,” is generally intended to include anything that may be utilized to bond bricks together, such as, for example: mortar, cement, caulk, and/or the like.

Relative terms, such as “top” or “bottom” may be used herein to describe one element's relationship to another element as illustrated in the drawings. It will be understood that relative terms are intended to encompass different orientations of an apparatus in addition to the orientation depicted in the drawings. By way of example, if an apparatus in the drawings is turned over, elements described as being on the “bottom” of other elements would then be oriented on “top” of the other elements. The term “top”, can therefore, encompass both an orientation of “top” and “bottom,” depending of the particular orientation of the apparatus. Similarly, if an apparatus in the drawing is turned over, elements described as “bottom” with respect to other elements would then be oriented on “top” the other elements. The terms “bottom” can, therefore, encompass both an orientation of top and bottom. When used in the claims, the term “top” with reference to an element means that the apparatus can be orientated such that the element is on top, even though the element may not be on top in different orientations of the apparatus. Similarly, the term “bottom” with respect to an element means that the apparatus can be orientated with such element on the bottom, even though the element may not be on the bottom in different orientations of the apparatus.

Relative terms, such as “horizontal” may also be used herein to describe one element's relationship to another element as illustrated in the drawings. It will be understood that relative terms are intended to encompass different orientations of an apparatus in addition to the orientation depicted in the drawings. By way of example, if an apparatus in the drawings is turned 90 degrees, elements described as being “horizontal” would then be vertical. The term “horizontal”, can therefore, encompass both an orientation of “horizontal” and “vertical,” depending of the particular orientation of the apparatus. When used in the claims, the term “horizontal” with respect to an element means that the apparatus can be orientated such that the element is horizontal, even though the element may not horizontal in different orientations of the apparatus.

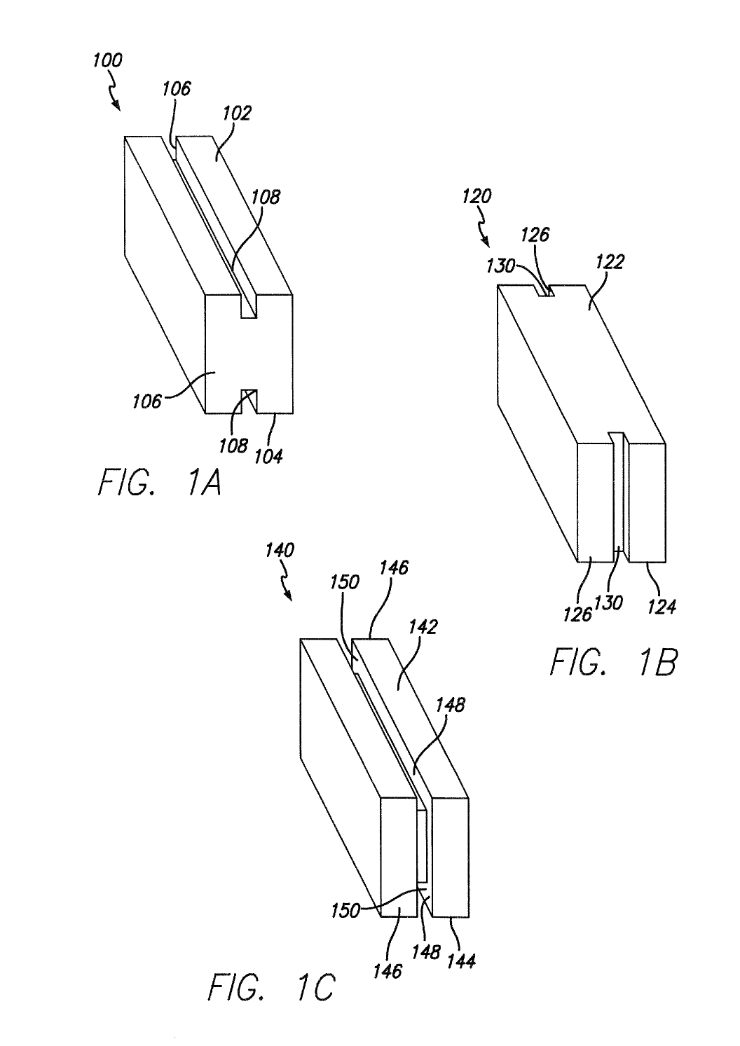

Disclosed is a pre-engineered brick panel formed of adjacent bricks. FIGS. 1A-C illustrate three exemplary bricks for use with various embodiments disclosed herein. In the embodiment shown in FIG. 1A, a brick 100 has the general shape of a rectangular solid, with a top surface 102, a bottom surface 104, and a pair of opposing end surfaces 106. A pair of grout channels 108 extends along the length of the top and bottom surfaces. In the embodiment shown in FIG. 1B, a brick 120 has a similar general shape and includes a top surface 122, a bottom surface 124, and a pair of opposing end surfaces 126. In the embodiment shown in FIG. 1B, a pair of grout channels 130 extends along the length of opposing end surfaces. In the embodiment shown in FIG. 1C, a brick 140 has a similar general shape and includes a top surface 142, a bottom surface 144, and a pair of opposing end surfaces 146. In the embodiment shown in FIG. 1C, a first pair of grout channels 148 extends along the length of the top and bottom surfaces and a second pair of grout channels extends along the length of opposing end surfaces 150 to completely encircle the brick 140.

Grout channels 108, 130, 148 and 150 can have any suitable cross-sectional shape, including square, rectangular, and semicircular cross-sectional shapes. The dimensions of the grout channels can vary in accordance with various embodiments within the scope of the present disclosure and will be readily determinable by one skilled in art. For example, the depth of the grout channels can be relatively deep, or it can be relatively shallow. Similarly, the width of the grout channels can be wide relative to the width of the respective side into which the grout channel is placed, or it can be very narrow relative to that width, in accordance with a user's design choices dependent on such factors as the weight of the bricks, the rigidity needed, characteristics of the grout being utilized in grout channels and the like.

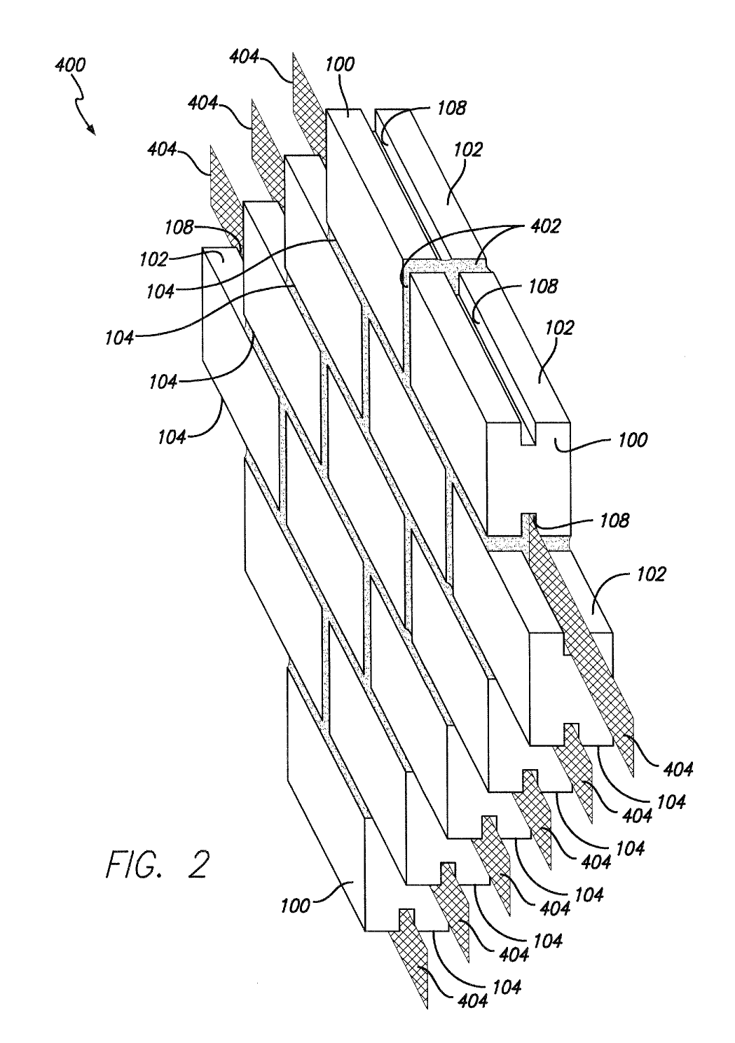

Referring now to FIG. 2, there is shown a portion of a brick panel 400 containing a plurality of adjacent bricks 100 separated by grout joints 402. The individual bricks are illustrated as having an offset alignment such as in a traditional brick wall. However, of course, any other suitable alignment pattern may be utilized in accordance with the various aspects of this disclosure. Each brick has a top surface 102 and a bottom surface 104, with grout channels 108 extending along the length of each top and bottom surface.

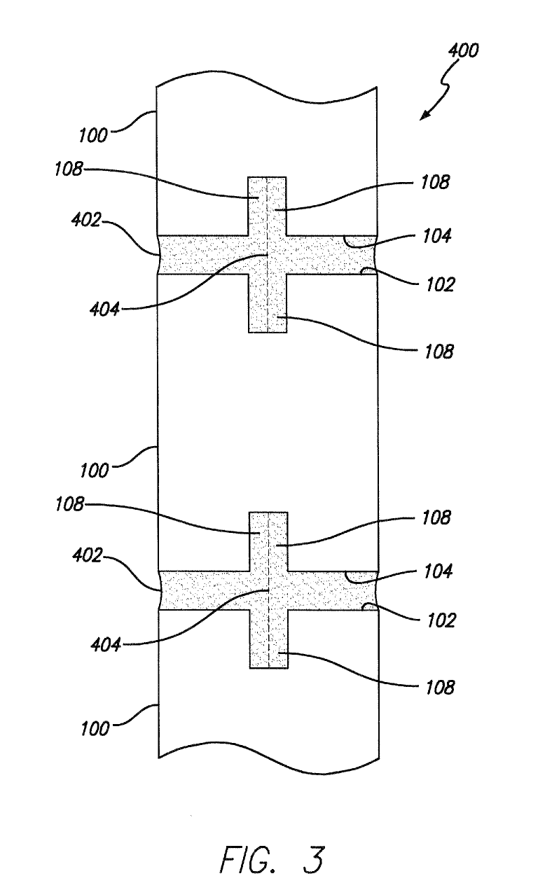

Referring additionally to FIG. 3, there is shown a cross-section of a portion a brick panel 400. It can be seen that the bricks 100 are positioned so that the top surface 102 of one brick is adjacent the bottom surface 104 of at least one other brick and the grout channels 108 in adjacent surfaces align with one another. As a result, when grout is applied into the grout joints 402, the grout fills at least a portion the grout channels undercutting a portion of the bricks to securely hold the bricks in place.

In accordance with further aspects of the disclosure, additional strength is provided to a brick panel 400 by utilizing a reinforcing material such as a mesh material 404 within the grout channels 108 channels of the bricks 100. In the embodiment shown in FIGS. 2 and 3, mesh strips are included in each grout channel and each mesh strip extends along the horizontal length of the panel.

In other embodiments utilizing bricks 140 having channels 148 and 150 that entirely encompass each brick 140, as illustrated in FIG. 1C, or other configurations, different configurations of the reinforcing material are utilized. For example, with bricks having channels that entirely encompass each brick; a mesh material can be placed in aligned horizontal and vertical grout channels.

Any suitable material can be used for the mesh material 404, such as a steel wire mesh. Using a mesh material allows for grout, when injected into the grout joints 402, to pass through holes in the mesh as well as passing into the grout channels 108. In this way, the mesh material provides additional rigidity and structural strength to the brick panel as a whole. In other aspects of the disclosure, other suitable reinforcing materials are utilized in addition to or in the place of a wire mesh material. For example, a strip of solid material such as extruded metal or other rigid material with holes drilled or otherwise placed within may be utilized; individual reinforcing bars or rebar may be placed within the grout channels.

Furthermore, in the embodiment shown in FIG. 2, the rows of bricks 100 allow for a continuous mesh strip 404 to extend all the way across the panel 400. In other embodiments, the bricks are aligned such that only short segments of mesh strips are utilized. That is, aspects of the present disclosure enable the pattern of alignment of bricks to be determined by a particular user and the usefulness of the grout joints 402 having the grout channels 108 disclosed herein, with or without the mesh strip, may be obtained essentially independent of the pattern of brick alignment.

In some aspects of the disclosure, in order for a grout material to fill the reinforcing material, such as mesh material 404, and to fill the grout joints 106, a grout material having a low viscosity to enable it to flow into any voids is utilized. Further, a process of injecting the grout material into the grout joints and grout channels can include tamping the panel and/or subjecting the panel to vibration or other agitation to further enable the grout to fill any voids.

By utilizing the grout joints having the grout channels described above, and particularly when utilizing the reinforcing material within the channels, a rigid and structurally sound brick panel is produced capable of pre-engineered, shipping, and installation into an existing location such as a fireplace to provide the aesthetic appeal of a brick paneled fireplace as well as the material benefits of a rigid brick panel. According to an aspect of the disclosure, installation of such a pre-engineered brick panel into a fireplace may be easily accomplished as follows.

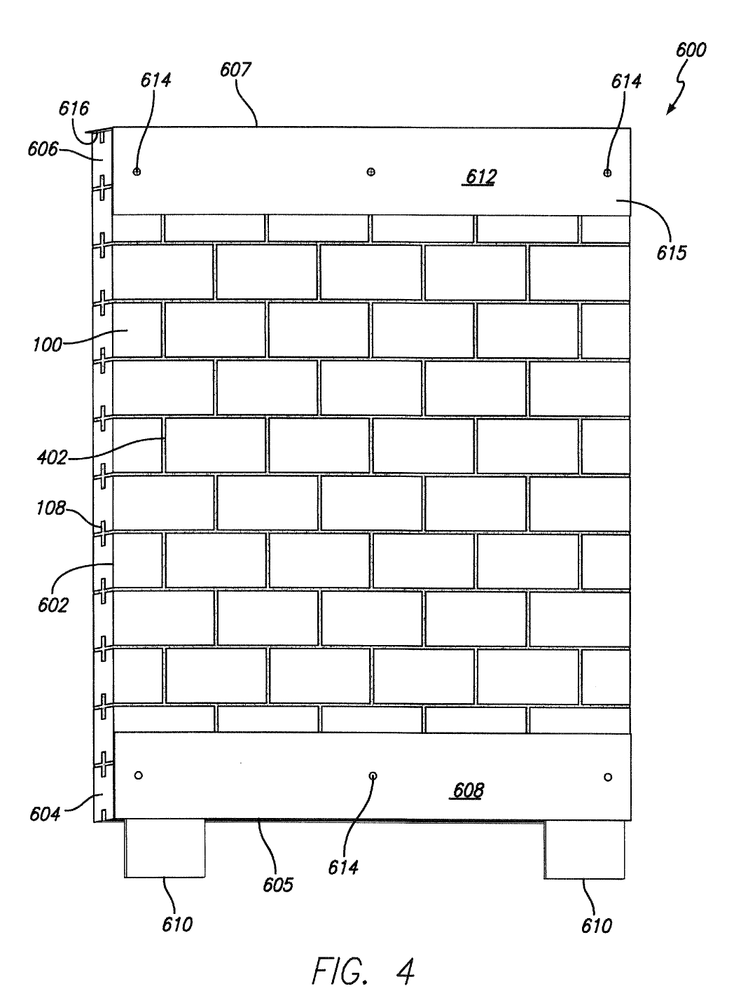

FIG. 4 is a rear perspective view of a pre-engineered panel 600 prepared for installation into an existing fireplace. Here, the panel includes a back 602, as well as a bottom portion 604, having a bottom surface 605 and a top portion 606, having a top surface 607. Attached to the bottom portion is a bottom support 608. The bottom support extends along the length of the bottom portion and has two flanges or tabs 610 extending below the bottom surface. Attached to the top portion is a top support 612. In the embodiment shown in FIG. 4, the top support is L-shaped, with a back surface 615 extending along the length of the bottom portion of the panel and an attachment surface 616 spaced above and apart from the top surface of the brick panel.

The bottom support 608 and the top support 612 are constructed of any suitable material, which may be the same or different. Suitable materials include, but are not limited to steel, anodized aluminum, or any other suitable rigid material for use in a fireplace. The supports are attached to the brick panel by any suitable means, such as by masonry screws 614. Other suitable attachment means include, without limitation, adhesives.

To install the pre-engineered panel 600, the panel is placed into a prepared fireplace (not illustrated) that includes slots in the base of the fireplace, next to a wall, to receive the flanges 610. That is, the flanges are configured to insert into slots (not illustrated) in a fireplace to secure the bottom of the brick panel to the base of the fireplace next to a wall. Once the flanges are inserted into the slots, the panel is pushed into place, i.e., the panel is positioned such that its back 602 rests against a wall of the fire place.

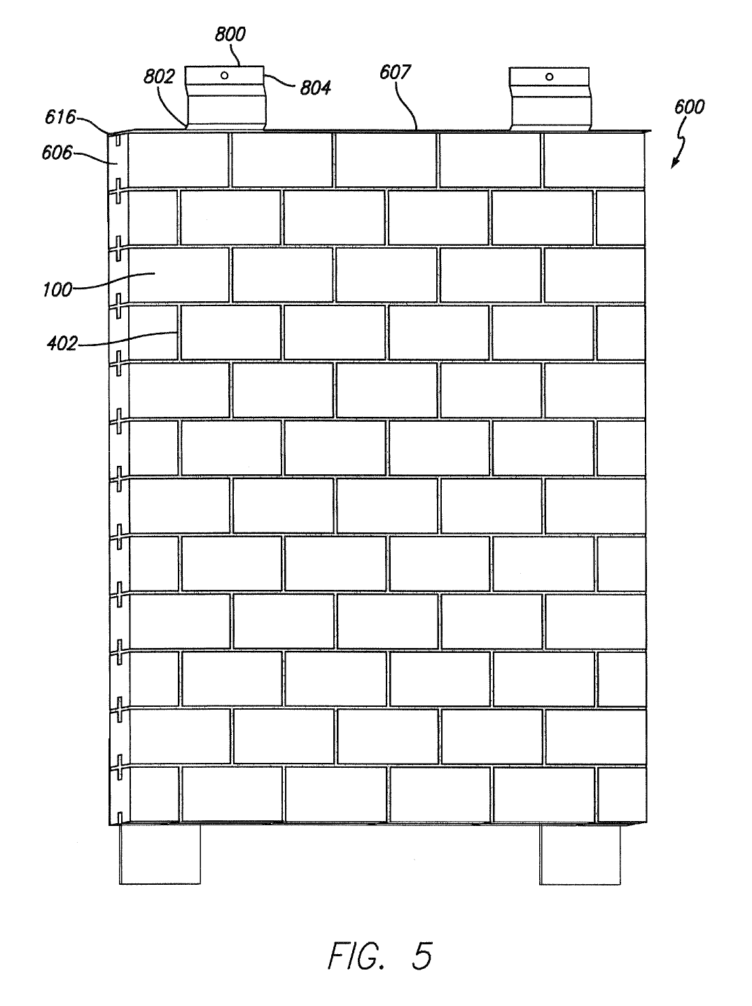

As shown if FIG. 5, a front perspective view, of the pre-engineered panel 600 shown in FIG. 4. A fastener 800 is then placed such that it secures the top portion 606 of the brick panel to the fireplace wall. Here, the fastener includes a bottom portion 802 interposed between top surface 607 of the panel and the attachment surface 616 of the top support to secure the fastener to the panel. The fastener further includes a top portion 804 to secure the fastener to the wall of the fireplace, for example, by utilizing a bolt, a screw, a rivet, or other suitable securing means. Alternatively, the top portion may be secured to the wall of the fireplace utilizing glue or any other suitable fastening material.

As disclosed herein, a simple and convenient system and method of manufacturing a pre-engineered brick panel and installing it into a fireplace has been described.

In the foregoing specification, various aspects of the invention have been described with reference to specific exemplary embodiments. Various modifications and changes may be made, however, without departing from the scope of the present invention. The specification and figures are illustrative, rather than restrictive, and modifications are intended to be included within the scope of the present invention. Accordingly, the scope of the invention should be determined by the claims and their legal equivalents rather than by merely the examples described.

With regard to particular embodiments described above, any benefit, advantage, solution to a problem, or any element that may cause any particular benefit, advantage, or solution to occur or to become more pronounced are not to be construed as critical, required, or essential features or components of any or all the claims.

As used herein, the terms “comprise,” “comprises,” “comprising,” “having,” “including,” “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition, or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

What is claimed is:

1. A pre-engineered brick panel comprising:
first and second adjacent bricks, spaced apart by a grout joint, a surface of the first brick adjacent to a surface of the second brick, each of the adjacent surfaces including a grout channel, the grout channels in adjacent surfaces aligned with one another; and
grout in the grout joint and the aligned grout channels.

2. The pre-engineered brick panel of claim 1, wherein the first brick adjacent surface comprises a top surface of the first brick and the second brick adjacent surface comprises a bottom surface of the second brick.

3. The pre-engineered brick panel of claim 1, further comprising a reinforcing material extending into both of the aligned grout channels.

4. The pre-engineered brick panel of claim 3, wherein the reinforcing material extends along the horizontal length of the panel.

5. The pre-engineered brick panel of claim 3, wherein the reinforcing material comprises a mesh material.

6. The pre-engineered brick panel of claim 5, wherein the mesh material comprises a steel wire mesh.

7. The pre-engineered brick panel of claim 1, further comprising a support attached to a bottom portion of the brick panel.

8. The pre-engineered brick panel of claim 7, wherein the support includes at least one flange extending below the bottom portion of the brick panel.

9. The pre-engineered brick panel of claim 1, further comprising a support attached to a top portion of the brick panel

10. The pre-engineered brick panel of claim 11, wherein the top portion of the brick panel has a top surface and the support includes at least one attachment surface spaced above and apart from the top surface.

11. The pre-engineered brick panel of claim 10, further comprising a fastener interposed between the top surface and the attachment surface.

12. A method of manufacturing a pre-engineered brick panel, comprising:
placing a first surface of a first brick, the first surface having a first grout channel, next to a second surface of a second brick, the second surface having a second grout channel, to align the grout channels and form a grout joint disposing grout in the grout channels and the grout joint.

13. The method of claim 12, wherein the grout is disposed into the grout channel and the grout joints by injection.

14. The method of claim 12, further comprising placing a reinforcing material in the aligned grout channels before disposing the grout.

15. The method of claim 14, wherein the reinforcing material comprises a mesh material.

16. A method of installing a pre-engineered panel having a bottom portion with a bottom surface and a top portion to a fireplace having a wall, comprising:
inserting at least one panel flange into a corresponding slot in a bottom of the fireplace, the at least one panel flange formed on the bottom portion of the panel and extending below the bottom surface of the panel;
placing the panel against the wall of the fireplace; and
attaching a fastener to the top portion of the panel and to the wall of the fireplace to install the panel to the wall.

17. The method of claim 16, wherein the top portion of the panel has a top surface and a support, the support including at least one attachment surface spaced above and apart from the top surface, and wherein the fastener is interposed between the top surface and the attachment surface.

18. The method of claim 17, wherein the panel comprises:
first and second adjacent bricks, spaced apart by a grout joint, a top surface of the first brick adjacent to a bottom surface of the second brick, each of the adjacent surfaces including a grout channel, the grout channels in adjacent surfaces aligned with one another; and
grout in the grout joint and both of the aligned grout channels;
wherein the first brick adjacent surface is top surface of the first brick and the second brick adjacent surface is the bottom surface of the second brick.
